(19) United States
(12) Patent Application Publication
(10) Pub. No.: US 2007/0269166 A1
(43) Pub. Date: Nov. 22, 2007

(54) Connection Module for Telecommunication and Data Technique

(75) Inventors: Frank Brode, Berlin (DE); Dietrich Rund, Berlin (DE); Hans-Peter Sandeck, Berlin (DE)

Correspondence Address: MERCHANT & GOULD PC, P.O. BOX 2903, MINNEAPOLIS, MN, 55402-0903, US

(73) Assignee: ADC GMBH, BERLIN (DE)

(21) Appl. No.: 10/583,653

(22) PCT Filed: Dec. 4, 2004
(86) PCT No.: PCT/EP04/13819

§ 371 Date: Mar. 28, 2007

(30) Foreign Application Priority Data
Dec. 20, 2003 (DE) 103 60 105.8

(51) Int. Cl. G02B 6/38; G02B 6/36

(52) U.S. Cl. 385/55; 385/89

(57) ABSTRACT

The invention relates to a connection module for telecommunications and data systems, comprising a base plate, on which connection modules for optical fibres or electric conductors can be arranged. According to the invention, the connection modules and the base plate have corresponding fixing elements and the base plate is provided with at least one connection module for optical fibres and at least one connection module for electric conductors. The invention also relates to a suitable connection module for the optical fibres and to a method for connecting said optical fibres.

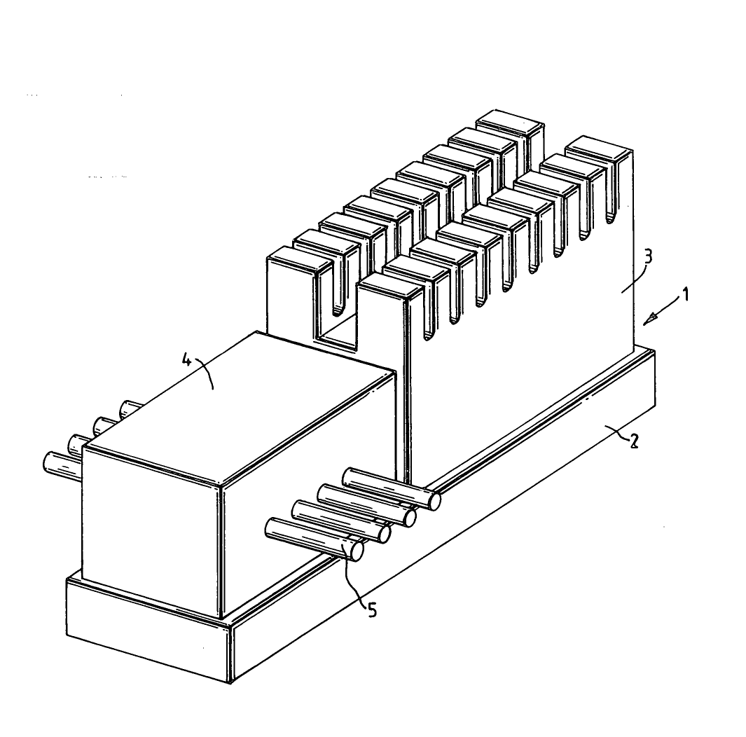

The invention relates to a connection module for telecommunication and data technique, a matching connecting module for optical waveguides as well as a method for the connection of optical waveguides.

For some time now, there has been an increasing requirement for broad-band capable digital networks, also in private buildings/residential houses and in industrially used rooms. As a transmission medium in these and other applications, optical plastic fibres are an interesting alternative to copper cores and glass fibres. Compared with glass fibres, the large core diameter of the optical plastic fibres permits a comparatively simple, favourably priced, field-capable connection technique. The same applies for the coupling of the fibres to active components (opto-electronics). The robustness and flexibility of the wires with optical plastic fibres additionally facilitate wire installation, the narrower bending radii permitting more freedom in the laying of the wires. Compared with copper cores, optical plastic fibres provide the benefit of resistance to EMC and physical separation, also manifesting a higher band-width, in particular optical plastic fibres with a gradient index profile. Against this background, optical plastic fibres have also been specified as transmission media in the past few years in the standardisation of interfaces for data transmission (AMT Forum, IEEE 1394).

For the connection of optical plastic fibres, plug-in connection techniques with a quick and simple-to-open and close connection as their objective have established themselves. The plastic fibres encased by a protective coating are connected with the plug by gluing, crimping or clamping. The plugs are provided with ferrules of plastic or metal or with fibre end sleeves in order to centre the ends of the plastic fibres. For optical processing of the fibre end surfaces, the techniques of grinding/polishing, cutting and the hot plate technique are used. The disadvantage of the plug connection techniques is the expenditure for the plug kits and the work necessary for fabrication of the plugs.

From EP 0 642 675 B1, we know of a connecting device for optical fibres with a transition in a funnel shape on its two ends, intended for an optical fibre to be inserted into the transition from its two sides, with the result that the fibres meet in the transition, the connecting device manifesting a first silicon part which has a flat surface, in which a groove with a V-shaped cross-section has been provided, the connecting device further manifesting a second part covering the groove in such a way that a channel with a triangular cross-section is formed. The second part comprises a glass material and manifests a flat side, which has contact with the grooved surface of the first part, with the V-shaped groove being etched to a deeper and wider cross-section on opposite ends of the first silicon part during the etching in order to form a funnel-shaped cross-section on each end of the device. The first and the second parts are connected by means of an anodic connector, by which the channel with the triangular cross-section is formed, a circle inscribed in the channel manifesting a diameter which only slightly exceeds the outer diameter of the optical fibre. The optical fibre can be a glass fibre or a plastic fibre in this context. The disadvantage of the known connector is the relatively expensive manufacture process due to the production of the silicon parts.

From DE 92 16 850 U1, a modular system for networks of voice and data communication for connection, division, shunting and arranging of fibre glass connection components and fibre glass wires as well as mixed set-up of copper lines/glass fibres is known, the modules in question comprising a carrier with elements to take functional elements and fitting elements connected with the carrier in order to connect the carrier with a base construction. In this, the carrier is a base plate and the base construction a carrier system with round bars. Either optical or electrical connecting modules are arranged on the base plate and stacked on top of one another if needed. An equipped base plate can also be termed as a connection module. This very flexible system is however relatively large and not suited for many applications in private buildings.

Therefore, the invention is based on the technical problem of creating a connection module for telecommunication and data technique which can be used more flexibly. A further technical problem is the provision of a connecting module for optical waveguides suitable for this purpose as well as providing a method for the production of the connection of two optical waveguides.

For this, a connecting module for optical waveguides and a connecting module for electric cores are arranged on a base plate in such a way that a mixed construction can be realised by equipping of a base plate alone. The connecting modules are preferably dimensioned in such a way that at least two connecting modules have room on the base plate, with the result that the base plate can be equipped exclusively with electrical or optical connecting modules or with an arbitrary mixture of combinations in the box-of-bricks principle, depending on the case of application. In this way, connecting modules for waveguides on the one hand and for copper cores on the other hand can be flexibly connected with one another, simultaneously enabling a compact, space-saving set-up.

Preferably, the connecting modules are detachably connected to the base plate, which also enables subsequent reconfiguration and also a replacement of individual defective connecting modules. However, it is also imaginable and advantageous to select a non-detachable solution in other cases.

In a further preferential embodiment, the base plate contains connecting elements making a carrier system, for example with clips to engage on round bars.

The base plate is preferably made of plastic, with the connecting element then being injection-moulded with the base plate in one piece as a function of the case of application. It is also possible for the connecting element and/or the base plate to comprise an electrically conducting material, in order to achieve a bonding, for example.

The connecting module for the electrical cores is preferably a connecting block. The contacts of the connecting block are preferably insulation displacement contacts. These connection blocks are extremely compact and the cores can be connected and also removed quickly and simply with suitable connection tools.

In a further preferential embodiment, the connecting module for the optical waveguides is made of plastic, with the result that it can also be produced by injection moulding.

In a further preferential embodiment, the connecting module for the optical waveguides is produced with fibre guidance structures, with which the two optical waveguides to be connected can be guided to contact in a defined way.

It is possible to provide the optical waveguides with fibre end sleeves or ferrules before connection, the optical connecting modules then possessing means for centring of the fibre end sleeves or ferrules. Fibre end sleeves or ferrules are the core of a plug and the means for the centring the core of a coupling. Such a connection is then practically the same as a simple plug-in type connection.

However, the fabrication of the ends of the waveguides with fibre end sleeves or ferrules is relatively expensive. Therefore, the connection is preferably direct without such ancillaries.

In a preferential embodiment, the fibre guidance structures are transient bores. These are preferably arranged in a line or matrix shape, their diameter having been adapted to the diameter of the optical waveguides in such a way that only a negligible lateral leeway of the ends of the fibres results. In the bores, the ends of the fibres are brought to contact. Withdrawal of the ends of the fibres is prevented by a clamping of the ends of the fibres and/or the outer casing of the optical waveguides.

In an alternative embodiment, the connecting module is in two parts, with V-shaped grooves having been inserted in a lower part and a top part being formed in such a way that an inserted optical waveguide is pushed into the V-shaped groove when the bottom and top parts are put together. In order to prevent withdrawal of the ends of the fibres, a clamping of the external casing of the optical waveguides can additionally be provided.

The advantage of these two embodiments is that the connecting modules can be built extremely compactly, as the entire construction space for voluminous couplings or plugs is not needed. Further, the connection can also be implemented very simply without great use of tools. It is quite easily possible to do without the benefits of the easily detached connections of plug and socket, in particular in applications in which the occupancy does not have to be changed very often. Further, the openings on the side walls can be widened to assume a funnel shape, in order to facilitate the insertion of the optical waveguides.

To prepare the connection, the ends of the optical waveguides are freed of their outer casing along a pre-determined length. After this, the ends of the waveguides are brought to a pre-determined length with a cut vertical to the axes by a cutting tool. As an alternative, the aforementioned top part for pushing the ends of the fibres into the V-shaped recesses can also be provided with means to cut off the ends of the optical waveguides, with the result that the work steps of cutting of the ends of the fibres and the clamping into the structures provided for the centring of the ends of the fibres are simultaneous. In this way, the time needed for the production of the connection is reduced even further and the aforementioned tool for cutting off the ends of the waveguides is not needed.

In order to achieve a lower optical attenuation of the coupling point and in order to reduce the demands made of the optical quality of the cut ends of the waveguides, a suitable immersion fluid (e.g. immersion gel) can be put between the fibre ends to be connected during installation. To simplify installation even further, the connecting module can already have been filled with the immersion fluid in the area of the joints. In the embodiment with the V-shaped recesses, the top part provided for pushing the fibre ends in simultaneously ensures the protection of the joint position moistened with gel against dust. Instead of pre-filling the connecting module for optical waveguides with an immersion fluid at the joint position, the aforementioned top part can also be designed to take the immersion fluid in such a way that the joint is only moistened with the immersion fluid emanating from the top part when the latter is pressed down, but remains dry before the actual jointing process.

In principle, the connecting module can be used for glass fibres (multi-mode or single-mode), HCS fibres (Hard Clad Silica) or optical plastic fibres. In particular, the optical plastic fibres are preferably suited due to their robustness and flexibility. The optical plastic fibres can have a step index profile, a gradient index profile or be multi-core fibres.

The connecting module for the optical waveguides according to the invention can also be designed without fitting agents for a base plate and, for example, be equipped directly with fitting agents for a different carrier system.

The invention is explained in more detail below on the basis of a preferential embodiment. The only figure shows a perspective portrayal of a connection module.

Connection module 1 entails a base plate 2 and also a connecting module 3 for electrical cores and a connecting module 4 for optical waveguides 5. The two connecting modules 3, 4 are suitably connected detachably or non-detachably with the base plate 2. The connection can, for example, be a screw, engagement or glued connection. In the portrayed connecting module, four optical waveguides 5 are inserted into unrecognisable transient bores from the one side and connected with four other optical waveguides inserted into the transient bores from the other side of connecting module 4, the opposite optical waveguides in connecting module 4 being brought into contact. In the example portrayed, only two connecting modules 3, 4 are shown on the base plate 2. However, other embodiments are quite easily possible in which more connecting modules 3, 4 are arranged on the base plate. Depending on requirements, a mixed set-up can also be done and the base plate equipped according to the box-of-bricks principle. Equipping and/or wiring of the connecting modules 3, 4 can be done quickly, directly at the place of installation, without large amounts of tools being necessary.

### LIST OF REFERENCE SIGNS

1 Connection module
2 Base plate
3 Connecting module
4 Connecting module
5 Optical waveguide

1. Connection module for telecommunication and data technique, entailing a base plate, onto which connecting modules for optical waveguides or electrical cores can be arranged, with the connecting modules and the base plate manifesting fitting agents corresponding to one another, wherein at least one connecting module for optical waveguides and at least one connecting module for electrical cores have been arranged on a base plate.

2. Connection module according to claim 1, wherein the connecting modules are detachably connected with the base plate.

3. Connection module according to claim 1, wherein the base plate is equipped with connecting elements to form a carrier system.

4. Connection module according to claim 1, wherein the base plate is made of plastic.

5. Connection module according to claim 1, wherein the connecting module for the electrical cores is designed as a connection block.

6. Connection module according to claim 1, wherein the connecting module for the electrical cores possesses contacts for the connection of the cores, the contacts being insulation displacement contacts.

7. Connection module according to claim 1, wherein the connecting module for the optical waveguides is made of plastic.

8. Connection module according to claim 1, wherein the connecting module for the optical waveguides has been provided with fibre guidance structures.

9. Connection module according to claim 8, wherein the fibre guidance structures are transient bores.

10. Connection module according to claim 8, wherein the connecting module is made in two parts, V-shaped grooves have been worked into the lower part and the top part has been designed in such a way that an inserted optical waveguide is pushed into the V-shaped groove when the bottom and the top part are pushed together.

11. Connection module according to claim 10, wherein at least one cutting device has been arranged in the top part, by means of which an optical waveguide can be cut off vertical to the axes.

12. Connection module according to claim 1, wherein a reservoir with an immersion fluid has been arranged in the connecting module for the optical waveguides.

13. Connection module according to claim 12, wherein the reservoir has been arranged in the top part.

14. Connecting module for optical waveguides, entailing a housing and fibre guidance structures, with at least two waveguides being able to be brought into contact in pairs in the housing, wherein the connecting module manifests fitting agents for a base plate.

15. Connecting module according to claim 14, wherein the housing is made of plastic.

16. Connecting module according to claim 14, wherein the fibre guidance structures are transient bores.

17. Connecting module according to claim 14, wherein the housing comprises at least two parts, with V-shaped grooves having been worked into a lower part and a top part being designed in such a way that an inserted optical waveguide is pushed into the V-shaped groove when the bottom and the top part are pushed together.

18. Connecting module according to claim 17, wherein at least one cutting device has been arranged in the top part, by means of which an optical waveguide can be cut off vertical to the axes.

19. Connecting module according to claim 14, wherein a reservoir with an immersion fluid has been arranged in the connecting module.

20. Connecting module according to claim 19, wherein the reservoir has been arranged in the top part.

21. Connecting module according to claim 14, wherein the connecting module has been provided with means for the centring of fibre end sleeves or ferrules.

22. Connecting module according to claim 14, wherein the optical waveguide is designed as an optical plastic fibre.

23. Connecting module according to claim 14, wherein the optical waveguide is designed as an HCS fibre or as a glass fibre.

24. Method for the connection of two optical waveguides, in particular of optical plastic fibres, by means of a connecting module according to claim 14, entailing the following procedural steps:
a) removal of the outer casing of the two optical waveguides;
b) cutting off the two fibre ends which are to be connected with one another vertical to the axes and
c) insertion of the two fibre ends from different sides of a fibre guidance element until they are opposite one another and in contact.

25. Method according to claim 24, wherein the joint position is filled with an immersion fluid.
